(19) United States
(12) Patent Application Publication
(10) Pub. No.: US 2026/0371230 A1
(43) Pub. Date: Nov. 19, 2026

(54) SYSTEMS AND METHODS FOR CONNECTION CONTINUITY DURING CALL RESTORATION

(71) Applicant: T-Mobile Innovations LLC, Overland Park, KS (US)

(72) Inventors: Khurram MIRZA, Renton, WA (US); Joel ARENDS, Renton, WA (US); Asfandyar DAYAN, Bellevue, WA (US); Madhuri KOTTA, Bellevue, WA (US)

(21) Appl. No.: 19/206,487

(22) Filed: May 13, 2025

(51) Int. Cl. H04W 48/16; H04L 65/1045; H04W 4/90

(52) U.S. Cl. CPC H04W 48/16; H04L 65/1045; H04W 4/90

(57) ABSTRACT

Systems, methods and devices are provided for connection continuity during a call restoration. The method includes receiving, by a wireless network, a connection request from an originating wireless device for a connection between the originating wireless device and a destination wireless device, detecting, by the wireless network, a connection failure at a terminal proxy-call session control function (P-CSCF) for the connection between the originating wireless device and the destination wireless device and, in response to detecting the connection failure, maintaining, by the wireless network, the connection request between the originating wireless device and the destination wireless device using a registration identifier at a disaster recovery P-CSCF.

### TECHNICAL BACKGROUND

Wireless networks, such as New Radio 5G and 4G LTE, often support connections using an IP multimedia subsystem (IMS) framework. Examples of connection may include voice over IP (VoIP) call, video calls and the like.

### OVERVIEW

Exemplary embodiments described herein include systems, methods, and processing nodes for connection continuity during call restoration. An exemplary method includes receiving, by a wireless network, a connection request from an originating wireless device for a connection between the originating wireless device and a destination wireless device, detecting, by the wireless network, a connection failure at a terminal proxy-call session control function (P-CSCF) that handles the connection between the originating wireless device and the destination wireless device and, in response to detecting the connection failure, maintaining, by the wireless network, the connection request between the originating wireless device and the destination wireless device using a registration identifier at a disaster recovery P-CSCF.

Further exemplary embodiments include a system for connection continuity during call restoration. The system includes an originating wireless device and a wireless network comprising a computing device communicatively connected to the originating wireless device, wherein the computing device is configured to receive a registration request from the originating wireless device, wherein the registration identifier is associated with a disaster recovery P-CSCF. The computing device is further configured to detect a connection failure for a connection between the originating wireless device and a destination wireless device and, in response to detecting the connection failure, maintain the connection between the originating wireless device and the destination wireless device using the registration identifier.

In yet a further exemplary embodiment, a non-transitory computer readable medium is provided. The non-transitory computer-readable medium stores instructions, when executed by a processor, configuring the processor to receive a connection request from an originating wireless device for a connection between the originating wireless device and a destination wireless device, detect a connection failure at a terminal P-CSCF that handles the connection between the originating wireless device and the destination wireless device and, in response to detecting the connection failure, maintain the connection request between the originating wireless device and the destination wireless device using a registration identifier at a disaster recovery P-CSCF.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates a time series flow for connection continuity during a call restoration in accordance with disclosed embodiments;

FIG. 3 illustrates an exemplary process flow for connection continuity during call restoration in accordance with aspects of this disclosure;

FIG. 4 illustrates an example of a computing device in accordance with aspects of this disclosure; and

FIG. 5 illustrates an exemplary processing node in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a core network, such as an NR 5G or 4G LTE, provides connection continuity during call restoration in an IMS based call.

For a call through IMS, such as a VoIP call, a session initiation protocol (SIP) INVITE is sent by an originating device to a destination device to establish a connection for the call between those devices.

Based on current implementations of a call flow in IMS, if a terminating proxy-call session control function (P-CSCF), which handles signaling towards a receiving device, in unavailable or non-responsive, often the call will fail and a restoration procedure is triggered, at the IMS, by terminating the connection request, e.g., call attempt, and providing a responsive terminating P-CSCF for the connection. This approach may not be ideal in some situations since it terminates the call attempt from the originating device, negatively affecting service for the originating device.

To reduce this negative impact on the originating device, a wireless network can trigger the restoration process of an IMS without terminating the connection request, thus ensuring minimal impact to a user of an originating device from a failure of the terminating P-CSCF of the destination device.

Once the wireless network detects that the SIP INVITE did not reach the terminating P-CSCF, either based on receiving an error or by not receiving a response after a set timeout period, the wireless network holds the SIP INVITE while the restoration process is ongoing. After a disaster recovery P-CSCF is created, which is a new terminating P-CSCF generated due to the failure of the original terminating P-CSCF, the destination device then registers with the disaster recovery P-CSCF. Once the destination device is successfully registered, the disaster recovery P-CSCF then forwards the SIP INVITE being held to the destination device, which enables the connection to be successfully established without failing the call.

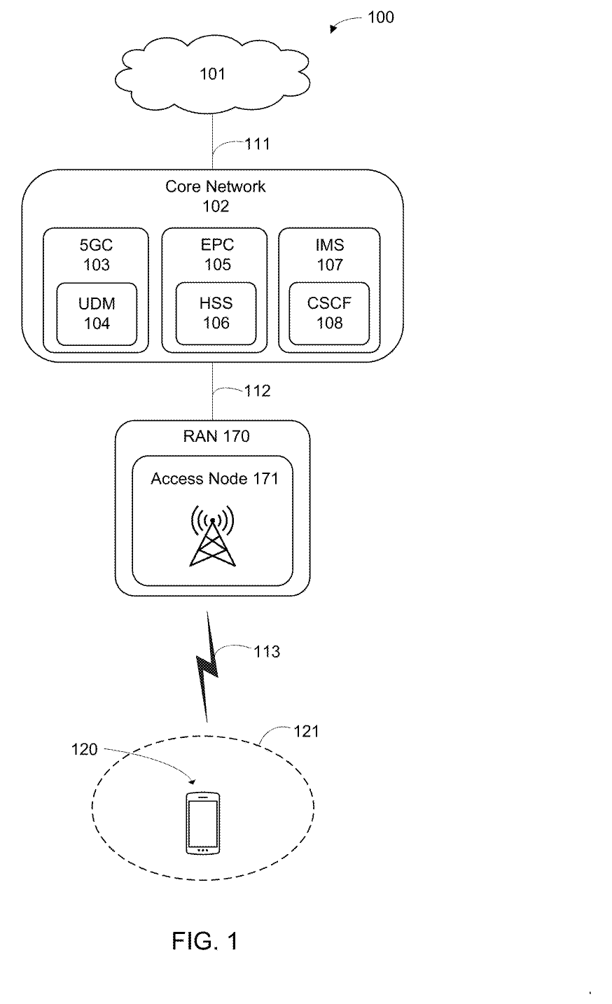

These and other examples will be described in greater detail below in relation to FIGS. 1-5.

FIG. 1 depicts an exemplary system 100 for connection continuity during a call restoration. System 100 includes a communication network 101, a core network 102, a radio access network (RAN) 170 and wireless devices 120.

Core network 102 is connected to communication network 101 over communication link 111. Core network 102 includes a 5G core (5GC) 103. 5GC 103 as used herein are core network components used for managing data for 5G networks. In embodiments, 5GC 103 includes an unified data management (UDM) 104. The UDM 104 stores subscriber identifiers, including authentication credentials, registration state, IMS subscriptions and profile information, and the like. In embodiments, 5GC 103 includes an access and mobility function (AMF). The AMF receives connection and session related information from a user device, such as an originating device, and is responsible for handling connection, registration and mobility management tasks on a 5G network. In embodiments, AMF receives an authentication request that includes a device identifier, AMF forwards the device identifier to UDM. In instances, 5GC 103 includes a session management function (SMF). The SMF is responsible for establishing protocol data unit (PDU) sessions and providing IP connectivity. In embodiments, the SMF may be used for proving the address of a terminating P-CSCF to a destination device.

Core network 102 includes an evolved packet core (EPC) 105. EPC 105 as used herein are core network components used for managing data for LTE, 4G, and/or other networks. In embodiments, EPC 105 includes a mobility management entity (MME) and a home subscriber server (HSS) 106. The MME is responsible for handling connection and mobility management tasks on an LTE/4G network. HSS 106 is responsible for storing a subscriber’s identifier, such as authentication credentials, IMS registration status, P-CSCF information, and the like. In embodiments, MME includes a packet data network gateway (P-GW). The P-GW may be used for providing a terminating P-CSCF address to a destination device.

Core network 102 also includes an IMS 107. IMS 107 as used herein is a framework used for delivering IP multimedia services, such as voice over internet protocol (VoIP) and/or other similar services, across a network. IMS 107 includes a call session control function (CSCF) 108. The CSCF 108 as used herein is a component of IMS 107 used for session control, signaling and routing in multimedia communication. In embodiments, the CSCF may be used for handling SIP communication.

It should be noted that core network 102 may include other components used for managing data for networks not described herein, such as a satellite core network. The core network 102 may have other types of core architecture (e.g., 6G core architecture) that at least perform some similar functions as and/or share at least some components with 5GC 103/EPC 105 with respect to connection and authentication of a user device. For example, embodiments described herein may utilize an AI-enhanced access and mobility function (AMF) of a 6G network.

The RAN 170 includes access nodes 171. In embodiments, the access nodes 171 include an evolved Node B (eNodeB) and a next generation Node B (gNodeB). As used herein, an eNode B is a base station in LTE/4G networks used for connecting a user device, such as wireless device 120, to core network 102. A gNodeB, as used herein, is a base station in new radio 5G networks and/or other networks used for connecting a user device to core network 102. The gNodeB may include, for example, centralized units (CUs) and distributed units (DUs).

RAN 170 is connected to core network 102 over communication link 112. RAN 170 may include other devices and additional nodes not described herein. For example, RAN 170 may include devices used for forwarding media files over IP from wireless devices 120 to core network 102.

In embodiments, system 100 may include two or more wireless devices 120. Wireless devices 120 are configured to operate in one or more coverage areas 121. Wireless devices 120 may include end-user wireless devices. Wireless devices 120 may include any device configured to send and receive data. In embodiments, wireless devices 120 communicate with RAN 170 over communication link 113. Examples of communication link 113 may include 5G network, 4G LTE, and the like.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless devices 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or so forth. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a PCF, a UDM function, an application function (AF), an AMF, an authentication server function (AUSF), and a SMF. Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM, such as UDM 104, function provides services to other core functions, such as the AMF, SMF, and NEF. The UDM may function as a stateful message store, holding information in local memory. The NSSF can be used by AMF to assist with the selection of network slice instances that will serve a particular device. Further, the NEF provides a mechanism for securely exposing services and features of the core network.

In instances, UDM 104 may store subscriber identifiers, such as a subscriber permanent identifier (SUPI). In instances, UDM may store secret cryptographic keys associated with a subscriber. For example, the secret keys may be used for temporarily authenticating a connection for wireless devices 120. In instances, UDM 104 may further include policy data for wireless devices 120. For example, UDM 104 may include subscription details for a subscriber. In instances, an AMF may terminate an authentication session with a wireless device of wireless devices 120 based on policy data associated with a subscriber identifier for wireless device stored in UDM 104.

Although one core network 102 is shown, multiple core networks 102 may be utilized. Alternatively, the single core network 102 may include a distributed, cloud-native, converged core gateway. Thus, the converged core gateway could connect an EPC 105 to 5GC 103 network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access nodes 171. The RAN 170 is disposed between the core network 102 and the end-user wireless device 120. Components of the RAN 170 may communicate directly with the core network 102 and others may communicate directly with the end user wireless device 120. The RAN 170 may provide services from the core network 102 to the end-user wireless device 120. It is understood that the disclosed technology may also be applied to communication between an end-user wireless device and other network resources, such as relay nodes, controller nodes, antennas, etc. Further, multiple access nodes may be utilized. For example, some wireless devices may communicate with an eNodeB and others may communicate with a gNodeB.

In additional embodiments, access nodes 171 may comprise two co-located cells, or antenna/transceiver combinations that are mounted on the same structure. Alternatively, access nodes 171 may comprise a short range, low power, small-cell access node such as a microcell access node, a picocell access node, a femtocell access node, and/or a home eNodeB device. As will be further described below, functionality for network node switching may be included within the access nodes 171.Access nodes 171 can be configured to deploy one or more different carriers, utilizing one or more RATs. For example, a gNodeB may support NR. It would be evident to one of ordinary skill in the art, in light of this disclosure, the many other combinations of access nodes and carriers that could be deployed.

The access node 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 120 may include any wireless device included in a wireless network. For example, the term “wireless device” may include a relay node, which may communicate with an access node. The term “wireless device” may also include an end-user wireless device, which may communicate with access nodes 171 through the relay node. The term “wireless device” may further include an end-user wireless device that communicates with the access node 171 directly without being relayed by a relay node.

Wireless devices 120 may be any device, system, combination of devices, or other such communication platform capable of communicating wirelessly with access nodes 171 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless devices 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for connection continuity during a call restoration may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

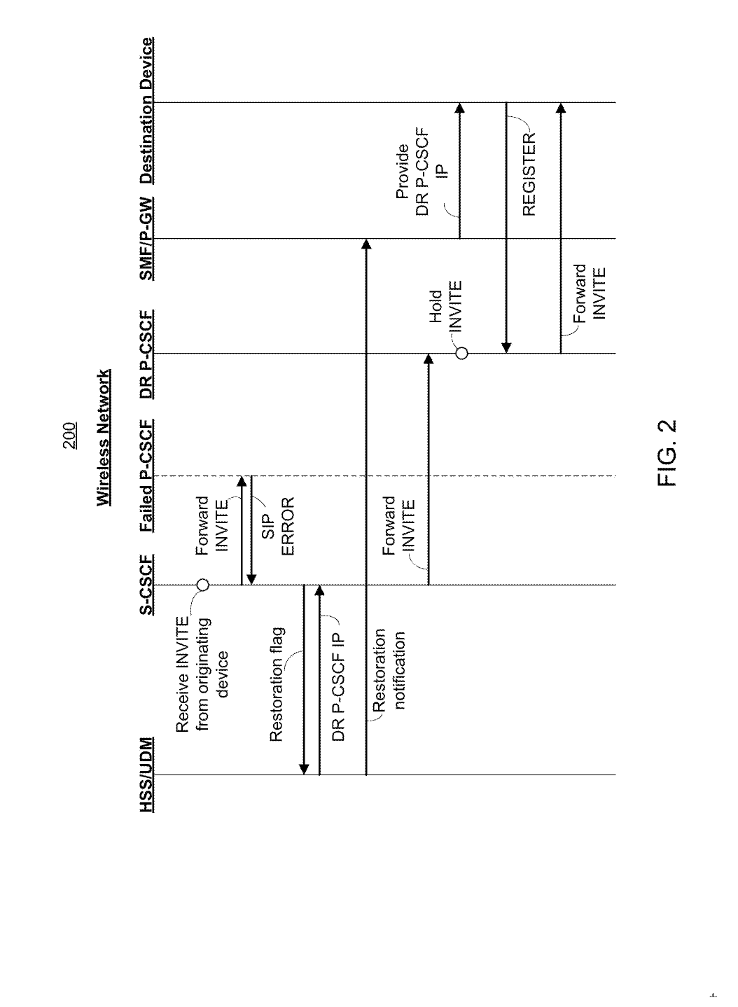

Now referring to FIG. 2, a time series flow 200 of a connection continuity during a call restoration is presented. In the first step of the example time series flow 200, the S-CSCF receives an SIP INVITE request from an originating device. The originating device may include a wireless device from wireless device 120 described in reference to FIG. 1. Once the S-CSCF receives the SIP INVITE, the S-CSCF forwards the SIP INVITE to the P-CSCF currently associated with a destination device, which may also include a device of wireless devices 120.

The time series flow continues by the S-CSCF detecting a connection failure at the P-CSCF. The detection may be based on receiving a SIP ERROR from the P-CSCF after forwarding the SIP INVITE. In instances, the detection may be based on a connection timeout, such as by not receiving a response from P-CSCF after a predetermined amount of time. S-CSCF and P-CSCF may be components of CSCF 108 described in reference to FIG. 1.

Continuing with the time series flow 200, once S-CSCF detects that the P-CSCF is no longer available, S-CSCF sends a restoration flag to an HSS, if connected to an LTE network, or an UDM, if connected to a NR 5G network. In embodiments, the S-CSCF may transmit the restoration flag using a server assignment request (SAR). For example, the S-CSCF may send a SAR to an HSS that includes an indication that S-CSCF is restoring the registration of a receiving device without requiring re-authentication. In instances, the S-CSCF may transmit the restoration flag using a hypertext transfer protocol representational state transfer application programming interface (HTTP RESTful API). For example, the S-CSCF may send the restoration flag through an HTTP POST/PUT operation to a resource of UDM through an API. The HSS and UDM may be the same as HSS 106 and UDM 104, described in reference to FIG. 1.

Once receiving the restoration flag from S-CSCF, HSS/UDM sends a registration identifier associated with a disaster recovery P-CSCF (DR P-CSCF) to the S-CSCF. In this example time series flow 200, the registration identifier is an internet protocol (IP) address associated with the DR P-CSCF, referenced herein as DR P-CSCF IP address. In embodiments, for a LTE network, the HSS may send the DR P-CSCF IP address using a server assignment answer (SAA). Instances, for a NR 5G network, the UDM may send the DR P-CSCF IP address to the S-CSCF using RESTful API.

Continuing with the example time series flow 200, the HSS/UDM then send a restoration notification to a P-GW, for LTE network connection, or a SMF, for the NR 5G network connection. In embodiments, the restoration notification may include the DR P-CSCF IP address. In instances, the restoration notification may include QoS for the current session, IMS bearer details and the like.

After receiving DR PCSCF IP, the S-CSCF forwards the SIP INVITE received from the originating device to the DR P-CSCF. Although the figures show an order of events for illustrative purposes, this step may occur simultaneously with, before or after the above-described step.

The time series flow 200 includes the SMF updating the destination device with the DR P-CSCF IP address. Once the destination device is updated with the DR P-CSCF IP address, the destination device registers with the DR P-CSCF. The DR P-CSCF holds the SIP INVITE, received from the S-CSCF, while the destination device registers with the DR P-CSCF. Once the destination device successfully registers, the DR P-CSCF forwards the SIP INVITE to the destination device. Once the SIP INVITE is received by the destination device, the connection between the originating device and the destination device is successfully established. The steps of the time series flow are performed on the initial SIP INVITE for the original connection request. Unlike previous solutions, the connection request is not terminated but rather forwarded and held at the DR P-CSCF until the destination device successfully registers.

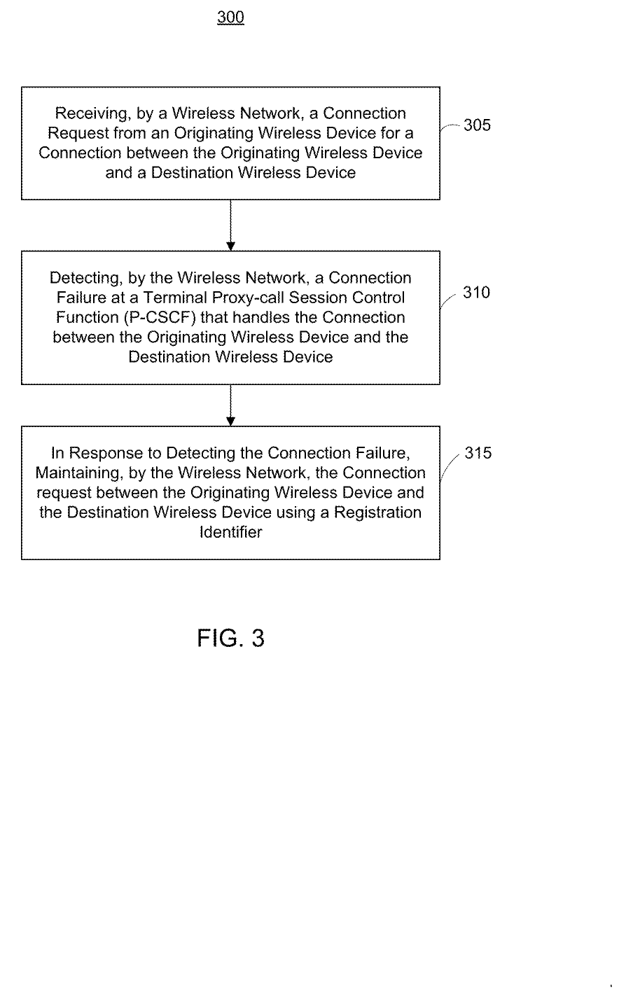

With reference to FIG. 3, a flow diagram of method 300 for connection continuity during call restoration is presented. Method 300 includes, at step 305, receiving, by a wireless network, a connection request from an originating wireless device for a connection between the originating wireless device and a destination wireless device. In embodiments, the connection request may be a SIP signal.

The method 300, at step 310, detecting, by the wireless network, a connection failure at a terminal P-CSCF that handles the connection between the originating wireless device and the destination wireless device.

At step 315, method 300 further includes, in response to detecting the connection failure, maintaining, by the wireless network, the connection request between the originating wireless device and the destination wireless device using a registration identifier. In embodiments, the registration identifier may be an address associated with a DR P-CSCF. In instances, the registration identifier may be a DR P-CSCF IP address.

In instances, the connection request may include a SIP INVITE message. In embodiments, maintaining the connection request may include holding the SIP INVITE message at the DR P-CSCF wireless network. In instances, the method 300 may include forwarding the SIP INVITE from the DR P-CSCF to the destination wireless device in response to a successful re-registration of the destination wireless device with theDR P-CSCF.

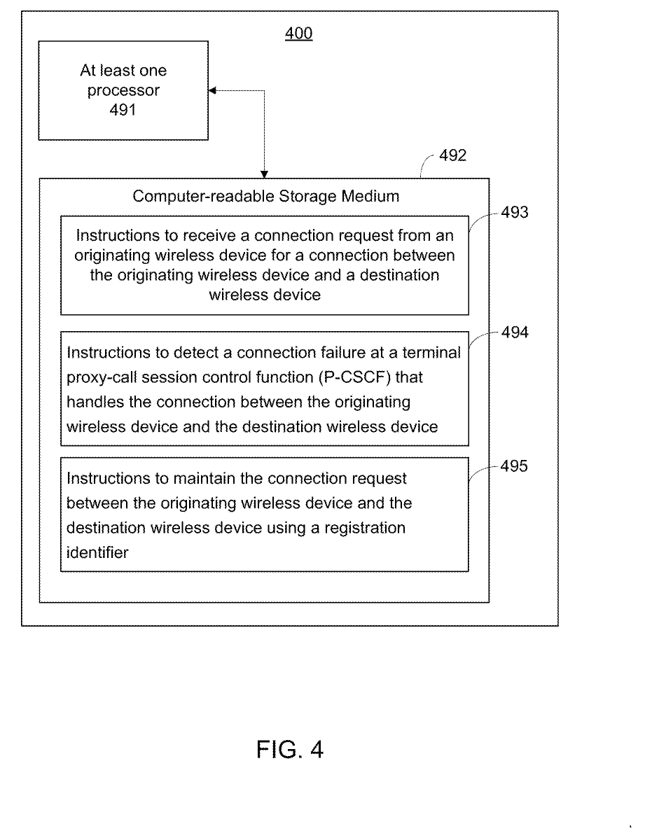

Now referring to FIG. 4, an example computing device 400 is presented. In embodiments, computing device 400 may include a node device, such as devices operating within communication network described in reference to FIG. 1. In this example, computing device 400 includes at least one processor 491 communicably coupled to a computer-readable storage medium 492. The at least one processor 491 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 492. In instances, at least one processor 491 may include electronic circuitry for performing instructions described in this disclosure.

In instances, computer-readable storage medium 492 may be any medium suitable for storing executable instructions. In examples, without limitation, computer-readable storage medium 492 may include read-only memory (ROM), random-access memory (RAM), erasable electrically programmable ROM (EEPROM), Solid State Drive (SSD), optical disc, and the like. Computer-readable medium storage 492 may be disposed within computing device 400. In embodiments, computer-readable storage medium 492 may be external, and communicably connected, to computing device 400. The instruction stored on computer-readable storage medium may be used to implement method steps described in reference to FIG. 3.

In this example, computer-readable storage medium 492 is encoded with a set of instructions 493, 494 and 495. In embodiments, executable instructions included in each block may be included in different blocks shown and blocks not shown.

Instruction 493, when executed by at least one processor 491, configures the at least one processor 491 to receive a connection request from an originating wireless device for a connection between the originating wireless device and a destination wireless device. In instances, the connection request may include an SIP INVITE message.

Instruction 494, when executed by at least one processor 491, configures the at least one processor 491 to detect a connection failure at a terminal P-CSCF that handles the connection between the originating wireless device and the destination wireless device. The originating and destination devices may be wireless devices 120, described in reference to FIG. 1.

Instruction 495, when executed by at least one processor 491, configures the at least one processor 491 to maintain the connection request (SIP INVITE) between the originating wireless device and the destination wireless device using a registration identifier. In instances, the registration identifier may be an IP address associated with the DR P-CSCF. For example, as described in reference to FIG. 2, the registration identifier may be a DR P-CSCF IP address. In embodiments, maintaining the connection request may include storing the SIP INVITE message at the wireless network. For example, as described in reference to FIG. 2, the SIP INVITE may be held at a DR P-CSCF.

In embodiments, computer-readable storage medium 492 may include instructions configuring the at least one processor 491 to forward the connection request, such as an SIP INVITE, to the destination device in response to a successful re-registration of the destination device with the DR P-CSCF.

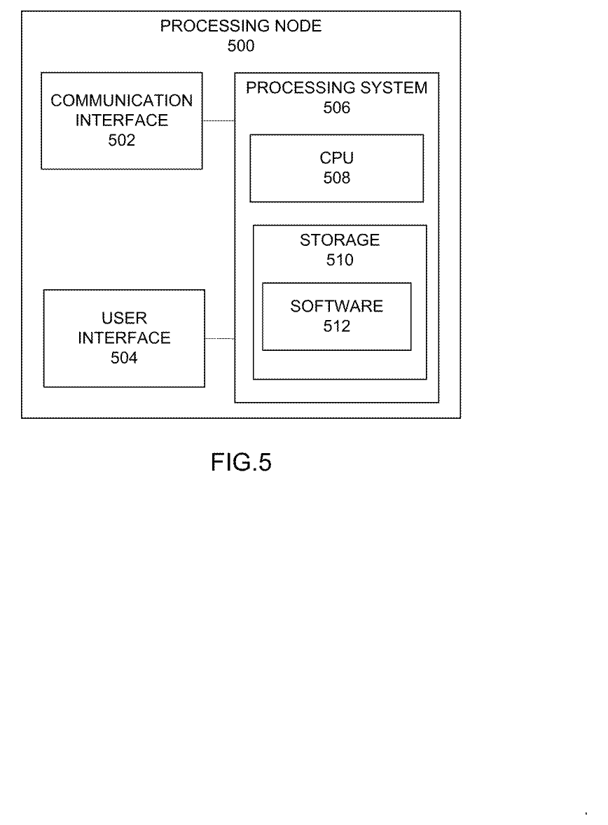

Now referring to FIG. 5, an example processing node 500, which may be configured to perform the methods and operations disclosed herein for network energy reduction. The processing node 500 includes a communication interface 502, user interface 504, and processing system 506 in communication with communication interface 502 and user interface 504. Communication interface 502 may include hardware components, such as network communication ports, devices, routers, wires, antenna, electronically steerable antennas (ESA), transceivers supporting satellite bands, etc. User interface 504 may include hardware components, such as touch screens, buttons, displays, speakers, etc.

Processing system 506 includes a central processing unit (CPU) or processor 508 and storage 510. Storage 510 may include a disk drive, flash drive, memory circuitry, or other memory device including, for example, a buffer. Storage 510 can store software 512 which is used in the operation of the processing node 500. Software 512 may include computer programs, firmware, or some other form of machine-readable instructions, including an operating system, utilities, drivers, network interfaces, signal processing algorithms, applications, or some other type of software. Processing system 506 may include a processor 508 and other circuitry to retrieve and execute software 512 from storage 510, which may be internal or external to the processing system 506. Processing node 500 may further include other components such as a power management unit, a control interface unit, etc., which are omitted for clarity. Communication interface 502 permits processing node 500 to communicate with other network elements. User interface 504 permits the configuration and control of the operation of processing node 500. Processing node 500 may be included in various elements of the wireless network including an access node, proxy call session control function (P-CSCF), gateway mobile location center (GMLC), radio resource control (RRC), inter-cell interference coordination (ICIC), medium access control (MAC), session border controller (SBC), and the like. In this example, software 512 may include the instructions described in reference to FIG. 4.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving, by a wireless network, a connection request from an originating wireless device for a connection between the originating wireless device and a destination wireless device;
detecting, by the wireless network, a connection failure at a terminal proxy-call session control function (P-CSCF) that handles the connection between the originating wireless device and the destination wireless device; and
in response to detecting the connection failure, maintaining, by the wireless network, the connection request between the originating wireless device and the destination wireless device using a registration identifier.

2. The method of claim 1, wherein the connection request is a session initiation protocol (SIP) signal.

3. The method of claim 2, wherein the connection request comprises a SIP INVITE message.

4. The method of claim 3, wherein maintaining the connection request comprises storing the SIP INVITE message at a disaster recovery P-CSCF.

5. The method of claim 4, further comprising forwarding the SIP INVITE to the destination wireless device in response to a successful re-registration of the destination wireless device.

6. The method of claim 1, wherein registration identifier is a disaster recovery P-CSCF internet protocol (IP) address.

7. A system, the system comprising:
an originating wireless device;
a wireless network comprising a computing device communicatively connected to the originating wireless device, wherein the computing device is configured to:
receive a registration request from the originating wireless device;
detect a connection failure at a terminal proxy-call session control function (P-CSCF) for a connection between the originating wireless device and a destination wireless device; and
in response to detecting the connection failure, maintain the connection between the originating wireless device and the destination wireless device using a registration identifier.

8. The system of claim 7 further configured to:
store the registration identifier in a unified data management (UDM) component.

9. The system of claim 7, wherein the registration identifier is a disaster recovery P-CSCF internet protocol (IP) address.

10. The system of claim 7, further configured to:
release a dedicated call bearer and provide a disaster recovery P-CSCF to the wireless device.

11. The system of claim 7, wherein the connection request comprises a session initiation protocol (SIP) INVITE message.

12. The system of claim 11, wherein a disaster recovery P-CSCF holds the SIP INVITE from the originating wireless device while the destination wireless device registers.

13. The system of claim 12, wherein the disaster recovery P-CSCF further sends the SIP INVITE to the destination wireless device upon registration of the destination wireless device.

14. The system of claim 7, wherein the computing device is further configured to detect the connection failure at the terminal P-CSCF for the connection between the originating wireless device and the destination wireless device based on a connection timeout.

15. A non-transitory computer-readable medium storing instructions, when executed by at least one processor, configuring the at least one processor to:
receive a connection request from an originating wireless device for a connection between the originating wireless device and a destination wireless device;
detect a connection failure at a terminal proxy-call session control function (P-CSCF) that handles the connection between the originating wireless device and the destination wireless device; and
in response to detecting the connection failure, maintain the connection request between the originating wireless device and the destination wireless device using a registration identifier.

16. The non-transitory computer-readable medium storing instructions of claim 15, wherein the connection request comprises a session initiation protocol (SIP) INVITE message.

17. The non-transitory computer-readable medium storing instructions of claim 16, wherein maintaining the connection request comprises storing the SIP INVITE message at a wireless network.

18. The non-transitory computer-readable medium storing instructions of claim 17, wherein the at least one processor is further configured to forward the SIP INVITE to the destination wireless device in response to a successful re-registration of the destination wireless device.

19. The non-transitory computer-readable medium storing instructions of claim 15, wherein the at least one processor is further configured to store the registration identifier in a unified data management (UDM) component.

20. The non-transitory computer-readable medium storing instructions of claim 15, wherein registration identifier is a disaster recovery P-CSCF internet protocol (IP) address.
